(19) United States
(12) Patent Application Publication
(10) Pub. No.: US 2020/0331737 A1
(43) Pub. Date: Oct. 22, 2020

(54) LIFTING DEVICE

(71) Applicant: Palfinger AG, Bergheim bei Salzburg (AT)

(72) Inventors: Richard REISCHAUER, Schalchen (AT); Paul HANDLECHNER, Mattsee (AT); Dominik GRAML, Hallwang (AT); Benjamin BERGMAYR, Wien (AT)

(21) Appl. No.: 16/922,306

(22) Filed: Jul. 7, 2020

Related U.S. Application Data
(63) Continuation of application No. PCT/AT2019/060004, filed on Jan. 8, 2019.

(30) Foreign Application Priority Data
Jan. 9, 2018 (AT) 50003/2018

(51) Int. Cl. B66F 11/04; B66F 17/00; B25J 5/00; B25J 13/08; B25J 19/02

(52) U.S. Cl. CPC B66F 11/046; B66F 17/006; B25J 19/021; B25J 13/088; B25J 5/007

(57) ABSTRACT

A lifting device has crane arm and a working device arranged on the crane arm and movable by the latter. The working device is arranged to be displaceable relative to the crane arm, and an actuating device for setting a predefined or predefinable target position of the working device relative to the crane arm or to a predefined or predefinable direction in space is provided. A sensor for detecting an actual position of the working device relative to the crane arm or to the direction in space is provided, the signals from which can be supplied to the actuating device. The actuating device moves the working device into the target position as a function of the signals from the sensor if the actual position is not equal to the target position.

### BACKGROUND OF THE INVENTION

The present invention concerns a lifting device and a vehicle having such a lifting device.

Lifting devices of the general kind set forth having a working device arranged displaceably on a crane arm of the lifting device have long been known in the state of the art. In that situation co-ordination of certain movements of the crane arm of the lifting device and certain movements of the working device arranged thereon can make high demands on the user of the crane. That is usually linked to increased operating involvement and reduced working speed, and can also easily result in incorrect operation, for example by an inadequately trained user or lack of attention. In regard to co-ordination of certain movements of the crane arm and certain movements of the working device that can result in unwanted damage to the crane, to the working device or also to a load which is possibly being lifted.

A lifting device of the general kind set forth is known from EP 0 397 076 A1. That publication discloses a forklift truck having a telescopic and vertically pivotable boom and a working device arranged pivotably thereon. The pivotal position of the working device is synchronised with the movement of the lift cylinder whereby it is possible to maintain the horizontal orientation of the working device upon a vertical pivotal movement of the boom arm. In the case of such a lifting device it is not possible without structural modifications to predetermine a different target position of the working device. Equally it is not possible without structural modifications to position the working device freely relative to the boom. Such a lifting device moreover only permits tracking adjustment of the horizontal orientation of the working device upon a pivotal movement of the boom arm in a vertical plane.

The object of the invention is to provide a crane which has expanded and facilitated operability as well as enhanced security in relation to operator error.

### SUMMARY OF THE INVENTION

That object is attained by a lifting device as described below and a vehicle having such a lifting device.

A lifting device according to the invention which has an actuating device for setting a predefined or predefinable target position of the working device relative to the crane arm or to a predefined or predefinable direction in space, is characterised in that:
at least one sensor detects an actual position of the working device relative to the crane arm or to the direction in space, the signals of which can be fed to the actuating device, and
the actuating device moves the working device into the target position in dependence on the signals of the at least one sensor if the actual position is not the same as the target position.

The lifting device therefore has an actuating device, by which the position of the working device relative to the crane arm can be adjusted. The position of the working device in that case can correspond to a predefined or predefinable target position of the working device relative to the crane arm or a predefined or predefinable direction or orientation of the working device in space. To detect the actual position of the working device, namely the position respectively prevailing in for example a working operation, of the working device relative to the crane arm or relative to a direction in space, there is provided at least one sensor. The signals from the sensor can be fed to the actuating device. The actuating device can move the working device into the target position in dependence on the at least one sensor. That can occur in the event of a deviation of the actual position relative to the target position, whereby the working device can be moved out of substantially any position into the target position or for example the working device can also be held in the target position during a working operation.

The actuating device can have a drive for varying a geometry of the crane arm, and the position of the working device is variable by the drive for varying the geometry of the crane arm. The drive can be in the form of at least one hydraulic cylinder for varying an angle of inclination of the crane arm, a bend position of the crane arm or an extension position of the crane arm. Pivotal movement of the crane arm about a for example vertical pivot axis can be made possible by a pivotal mechanism. In general, the crane arm, parts of the crane arm relative to each other, and the working device relative to the crane arm or relative to the parts of the crane arm can be moved by the actuating device.

Further, the actuating device has an actuator arranged between the crane arm and the working device, and the position of the working device is variable by that actuator. The working device can be moved, for example, relative to the crane arm without a change in the geometry of the crane arm by such an actuator, that is to say a motion device. Such an actuator can be for example in the form of a rotator or also a rotary drive, a rack or a hydraulic cylinder. Pivotal movement, tilting, rotation or displacement of the working device can be made possible by means of the actuator.

An actuating device which includes a crane arm which is of variable geometry and an actuator arranged between the crane arm and the working device is also conceivable.

Further, the target position is a position of the working device in at least one predetermined angle in space. A predetermined angle in space can for example correspond to an angle of an axis of the working device relative to the vertical or horizontal. In that respect in other words it is possible to refer to an absolute position of the working device in space.

It is possible that the at least one sensor is in the form of an angle sensor, a force or moment sensor, an inclination sensor, an acceleration sensor, a proximity sensor, an optical detection device or a device for emitting and receiving sound waves, in particular ultrasound, or a device for emitting and receiving electromagnetic waves, in particular radar or laser light. In that way—depending on the respective configuration of the sensor—it is possible for the relative position of the working device with respect to the crane arm and/or the position of the working device with respect to the direction in space to be determined. A deviation of the actual position of the working device relative to the target position of the working device can also be determined or detected by a sensor of suitable configuration.

It can be advantageous if the actuating device has a control means to which the signals of the at least one sensor for detecting an actual position of the working device relative to the crane arm or the direction in space can be fed. The control means of the actuating device can for example firstly put the sensor signals supplied thereto (raw data) of a sensor into a signal format which can be further processed by the control means. In that way, the signals of the at least one sensor can be incorporated into the movement of the working device by the actuating device.

In that respect it can be advantageous if the control means is arranged on the working device or is provided in a crane control means of the crane arm. The control means can therefore be separate from the crane control means of the crane arm, for example as an additionally installed module, or in the form of part of the crane control means, for example integrated into same. The crane control means can include a stationary operating station or also a mobile radio console, wherein the control means can also be respectively provided in the operating station or in the radio console.

The control means can basically have an operating mode in which the actuating device moves the working device into the target position in dependence on the signals supplied to the actuating device from the at least one sensor, if the actual position is not the same as the target position.

It can be advantageous if there is at least one sensor, by which a variation, caused by pick-up of a load by means of the working device, in the position of the working device relative to the crane arm or relative to the direction in space can be detected. Further, at least one sensor can be provided, by which a mechanical loading on the working device, caused by pick-up of a load by means of the working device, can be detected. Such a mechanical loading on the working device can be for example a moment loading.

In that respect, when a load is picked up, engagement of the working device on the load outside the center of gravity of the load can be detected. Thus, for example, it is possible to detect a movement of the working device that occurs when picking up a load—therefore for example a pivotal movement, tilting, rotation or displacement of the working device—. Such a movement can be caused for example by a moment acting on the working device if for example an extended load is hit or engaged by the working device at a certain spacing from the centre of gravity of the load.

In that respect, the at least one sensor for detecting an actual position of the working device can form the at least one sensor. The sensor, by which a variation in the position of the working device relative to the crane or relative to the direction in space, caused by pick-up of a load by means of the working device, can be detected, or by which a mechanical loading on the working device, caused by pick-up of a load by means of the working device, can be detected, can therefore be formed by the sensor for detecting the actual position of the working device. The sensor for detecting the actual position of the working device can thus detect a change in the currently prevailing position for example by detection of the respectively currently prevailing position in a working operation of the working device relative to the crane arm or relative to a direction in space, and it is possible to deduce therefrom a variation in the position of the working device relative to the crane arm or relative to the direction in space or a mechanical loading on the working device.

Further, the actuating device is adapted to assist or permit movements exerted by a user manually or pedally on the working device or on a load picked up by the working device or by gesture relative to the working device. Thus for example by at least one of the installed sensors—possibly in an operating mode of the actuating device which is specifically suitable for that purpose—it is possible to convert an action of the user on the working device or also on a load picked up by the working device into a movement of the working device. Thus for example the working device or a load picked up by the working device can be moved into a position which can be predetermined by the user by direct positioning (orientation). It is also conceivable that the working device can be positioned or oriented by gesture control by the user, by virtue of one of the installed sensors.

Basically, the working device can be in the form of a load pick-up means. In that respect, different configurations of a load pick-up means like for example a load pick-up means in the form of a manipulator, rotator, tilt rotator or gripper that permits generally physical interaction with the environment are conceivable. The load pick-up means can respectively include an actuator arranged thereon.

The at least one sensor for detecting an actual position of the working device can be arranged on or in the working device. The sensor can therefore be arranged on the working device or can be arranged in the working device or in a part of the working device. The sensor can equally be arranged on the crane arm or in the crane arm or in a part of the crane arm. It is also possible for the sensor to be arranged between the working device and the crane arm. It is also not out of the question that the sensor can be arranged in or on a vehicle.

A particularly advantageous configuration of the lifting device can be afforded if the lifting device is in the form of a loading crane.

As was already mentioned in the opening part of this specification protection is also claimed for a vehicle having a lifting device as described hereinbefore.

### BRIEF DESCRIPTION OF THE DRAWINGS

Embodiments by way of example of the invention are described with reference to the Figures, in which:

FIG. 1 shows an embodiment of a lifting device with an aerial working platform,

FIG. 2 shows a vehicle having a lifting device,

FIGS. 3a and 3b show a vehicle having a lifting device in various pivotal positions,

FIG. 4 shows a further structure of a vehicle having a lifting device,

FIGS. 5a and 5b are detail views of a crane arm with an actuator arranged thereon, and

FIG. 6 is a detail view of a crane arm with a working device arranged thereon.

### DETAILED DESCRIPTION OF THE INVENTION

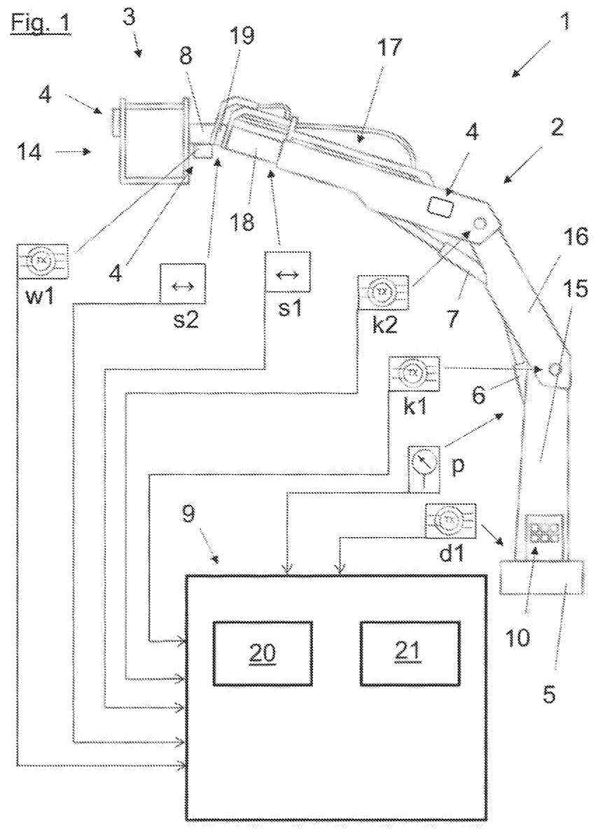

FIG. 1 shows an embodiment of a lifting device 1 in the form of a crane arm 2 with a working device 3 arranged thereon in the form of an aerial working platform 14 and a control means 9 with associated sensor system. The crane arm 2 has a crane base 5, a crane column 15, a lift arm 16 and an articulated arm 17, wherein the articulated arm 17 for changing the length of the crane arm 2 has a telescopic first crane extension arm 18 and a telescopic second crane extension arm 19. In the illustrated embodiment the sensor system of the lifting device 1 includes an extension position sensor s1 for detecting the extension position of the first crane extension arm 18, an extension position sensor s1 for detecting the extension position of the second crane extension arm 19, a rotary angle sensor d1 for detecting the rotary position about a vertical axis of the crane column 15 relative to the crane base 5, a bend angle sensor k1 for detecting the bend angle position of the lift arm 16 relative to the crane column 15, a bend angle sensor k2 for detecting the bend angle position of the articulated arm 17 relative to the lift arm 16 and a pressure sensor p for detecting the hydraulic pressure in the hydraulic cylinder 6 (lift cylinder) of the lifting device 1. Pressure detection can also be implemented for the hydraulic cylinder 7 (articulation cylinder) of the lifting device 1. In addition the sensor system in the illustrated embodiment includes a sensor 4, by means of which the position of the working device 3 or the aerial working platform 14 can be detected. The position of the working device 3 or the aerial working platform 14, detected by the sensor 4 in this embodiment in the form of an angle sensor w1, can correspond to a position relative to the crane arm 2 or a direction in space. Thus for example a respective rotary angle position of the working device 3 or the aerial working platform 14 about one of the three axes in space can be detected by the angle sensor w1. It is also possible that a sensor 4 for detecting the position of the working device 3 or the aerial working platform 14 is arranged on the working device 3 or the aerial working platform 14 or the crane arm 2 itself. The values detected by the sensor system are fed to the control means 9 by way of suitable connections, whether a wired measurement line or a wireless connection. The control means 9 can have a memory 20 and a computing unit 21. The control means 9 can be integrated in the crane control means 10 or arranged on the working implement 3.

The position of the working implement 3 or the aerial working platform 14 can be altered by a change in geometry of the crane arm 2 or by an actuator 8 disposed between the crane arm 2 and the working device 3 or the aerial working platform 14.

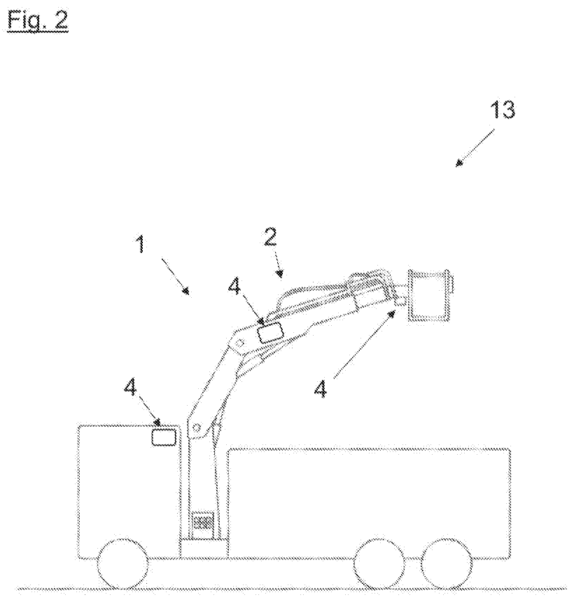

FIG. 2 shows a side view of a vehicle 13 with a lifting device 1 in the form of a crane arm 2. The configuration of the lifting device 1 in that respect substantially corresponds to that shown in FIG. 1.

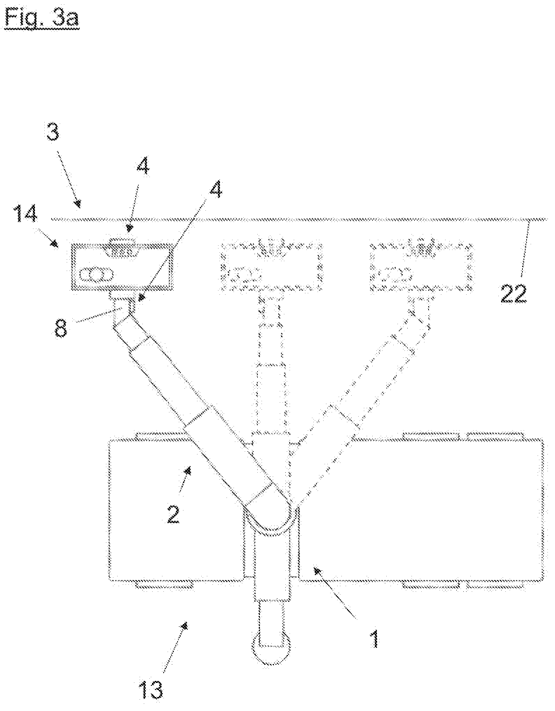

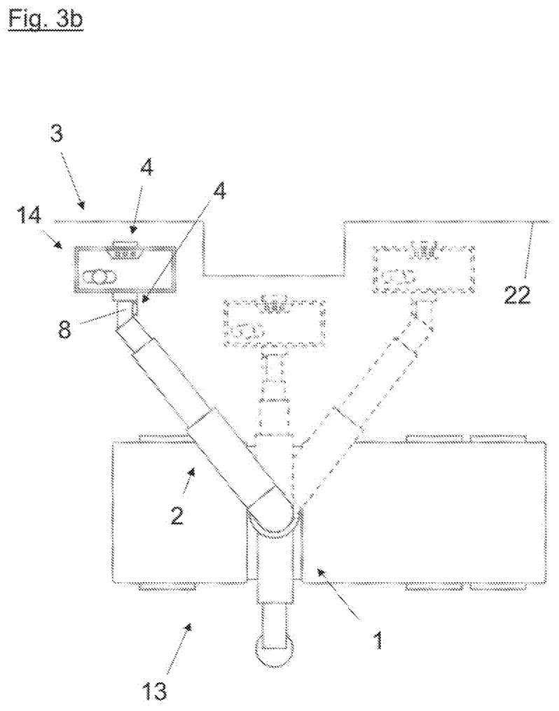

FIG. 3a shows a plan view of a vehicle 13 with a lifting device 1 in the form of a crane arm 2, having a crane arm 2 and a working device 3 in the form of an aerial working platform 14, which is arranged on the crane arm 2 and is movable by same and an actuator 8. In this respect the configuration of the lifting device 1 again substantially corresponds to that shown in FIG. 1. As illustrated it is possible for a sensor 4 for detecting the position of the working device 3 or the aerial working platform 14 to be arranged on the working device 3, the crane arm 2 and the vehicle 13 itself.

The working device 3 in the form of the aerial working platform is arranged displaceably relative to the crane arm 2, in which respect FIG. 3a shows various pivotal positions about a vertical axis of the working device 3 in the form of an aerial working platform 14 relative to the crane arm 2 during the pivotal movement of the crane arm 2 about the crane column 5. Detection of the relative position of the working device 3 or the aerial working platform 14 relative to the crane arm 2 and also detection of the position of the working device 3 or the aerial working platform 14 in space can be effected by way of a sensor 4 arranged on the working device 3 or the aerial working platform 14 or on the lifting device 1. As shown in the example in FIG. 3a a target position of the working device 3 can correspond to a predetermined direction in space. As illustrated the working device 3 in the form of the aerial working platform can initially be oriented parallel to a wall 22 (left-hand view of the crane arm 2 and the aerial working platform 14). Upon a pivotal movement of the crane arm 2 about a vertical pivot axis the working device 3 in the form of the aerial working platform can be moved or pivoted by the actuating device—which in this embodiment is formed by the crane arm 2 and the actuator 8—in such a way that, during the pivotal movement of the crane arm 2, the working device 3 is still held in the target position, that is to say in the orientation parallel to the wall 22. In that case the target position, therefore the predefined direction in space, can follow an absolute direction in space or, as also shown in FIG. 3a, it can follow the direction of the wall 22. An application in that respect is shown in FIG. 3b.

The view in FIG. 3b substantially corresponds to that in FIG. 3a, but here the wall 22 is of an uneven configuration. The signals from the sensor 3 can be fed to the actuating device which as illustrated is afforded by the crane arm 2 and the actuator 8, and the working device 3 in the form of the aerial working platform 14 can be held in the desired target position during the pivotal movement of the crane arm 2. In the example in FIG. 3a and also FIG. 3b the target position can approximately correspond to a uniform distance of the working device 3 in the form of the aerial working platform 14 relative to the wall 22.

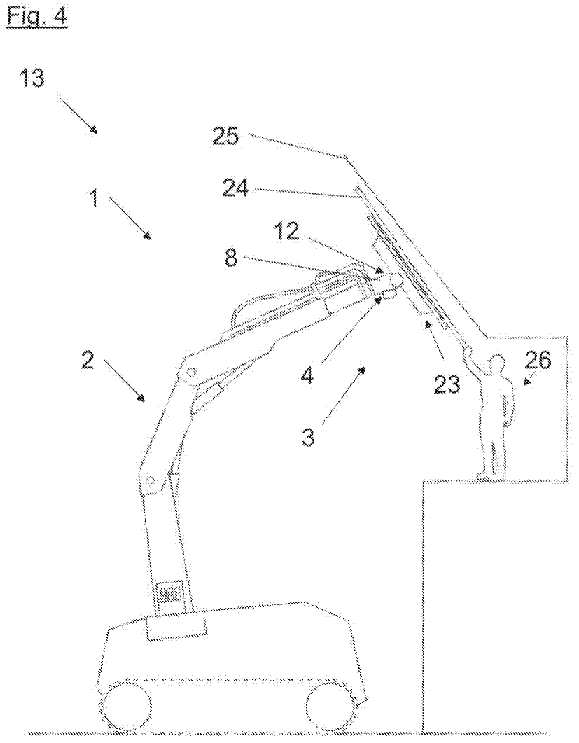

FIG. 4 shows a further configuration of a vehicle 13 in the form of a crawler crane having a lifting device 1 in the form of a crane arm 2 with a working device 3 in the form of a vacuum suction gripper 23. Vacuum suction grippers 23 can be used for example in handling flat load items 11 like for example a glass panel 24. FIG. 4 shows the installation of a glass panel 24 on a façade 25. The lifting device 1 which can be equipped similarly to the embodiment of the lifting device 1 shown in FIG. 1 again has a sensor 4 for detecting the instantaneous position of the working device 3 or the vacuum suction gripper 23. An actuator 8 is arranged between the crane arm 2 and the working device 3 or the vacuum suction gripper 23. In the structure shown in FIG. 4 the lifting device 1 has a further sensor 12 which can detect a mechanical loading on the working device 3 by the load item 11. The moment loading or the gravitational force exerted on the vacuum suction gripper 23 or the actuator 8 by the glass panel 24 can be detected by the further sensor 12, for example in the form of a force sensor. In that way it can be made possible for a user 26 to permit or assist movements exerted on the working device 3 or on a load 11 picked up by the working device 3, manually or pedally—that is to say by hand or by foot—. In the illustrated configuration for example fitment of the glass panel to the façade 25 can thus be facilitated by direct manual orientation of the glass panel 24 by the user 26. It is also conceivable for the further sensor 12 to be in the form of an optical sensor and for indirect orientation of the glass panel 24 and the working device 3 to be effected by gestures of the user 26 relative to the working device 3.

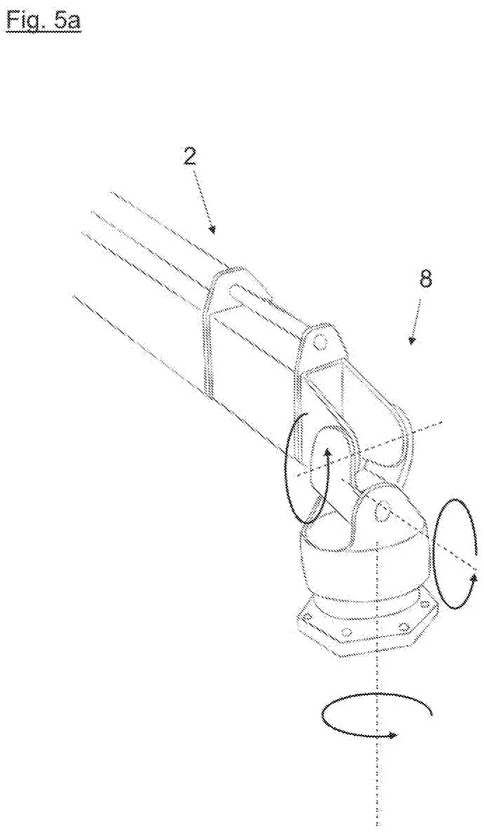

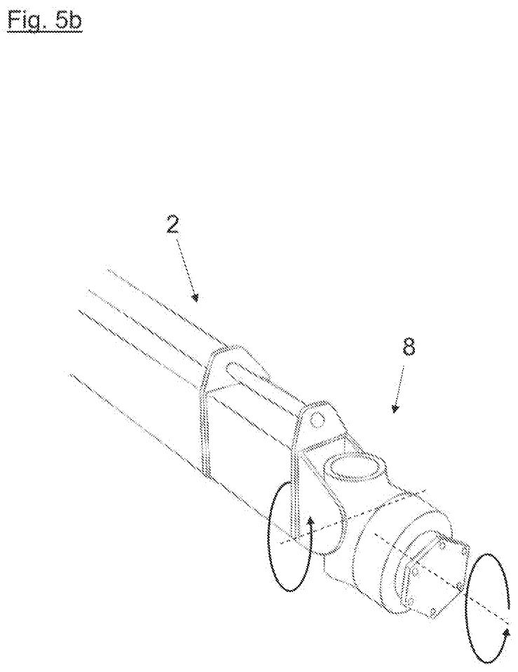

FIGS. 5a and 5b show detail views of a crane arm 2 with an actuator 8 arranged thereon in the form of a tilt rotator in various pivotal positions. The crane arm 2 can basically be similar to the configuration of the crane arm 2 shown in FIG. 1. An actuator 8 as shown in FIG. 5a can perform or permit a pivotal movement about three axes in space. In that way a working device (not shown) arranged on the actuator 8 can be positioned substantially freely in space or relative to the crane arm 2. An actuator 8 as shown in FIG. 5b can allow a pivotal movement about two axes in space. The actuator 8 shown in FIG. 5a and FIG. 5b can have a respective sensor (not shown), by which it is possible to detect the position of a working device arranged on the actuator 8.

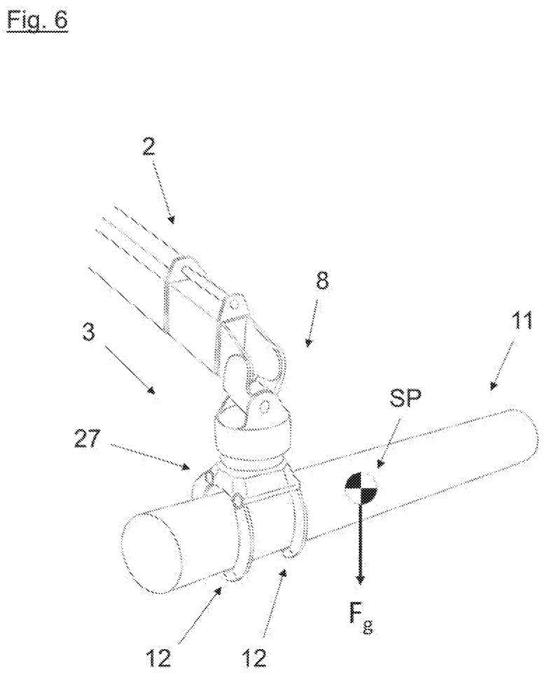

FIG. 6 shows a detail view of a crane arm 2 designed as in FIG. 5a having an actuator 8 arranged thereon and a working device 3 arranged thereon in the form of a gripper 27. In the illustrated structure the gripper 27 has in the gripper tips respective sensors 12 in the form of pressure sensors, by means of which it is possible to detect a force acting on the working device 3 by virtue of the load 11 which has been picked up. Thus for example in the event of the working device 3 engaging the load 11 outside the centre of gravity SP a moment caused by the gravitational force F_{g} of the load 11—and thus a force—can act on the working device 3, which can be detected by the sensors 12 or by a comparison of the forces ascertained by the sensors 12. A force acting on the actuator 8 can equally be detected by a sensor (not shown) integrated in the actuator 8.

### LIST OF REFERENCES

1 lifting device
2 crane arm
3 working device
4 sensor
5 crane base
6, 7 hydraulic cylinder
8 actuator
9 control means
10 crane control means
11 load
12 sensor
13 vehicle
14 aerial working platform
15 crane column
16 lift arm
17 articulated arm
18 first crane extension arm
19 second crane extension arm
20 memory
21 computing unit
22 wall
23 vacuum suction gripper
24 glass panel
25 façade
26 user
27 gripper
gravitational force F_{g}
centre of gravity SP
p pressure sensor
s1, s2 extension position sensor
d1 rotary angle sensor
k1, k2, k3 bend angle sensor
w1 angle sensor

1. A lifting device having a—preferably bendable—crane arm and a working device which is arranged on the crane arm and is movable thereby, wherein the working device is arranged displaceably relative to the crane arm, wherein there is provided an actuating device for setting a predefined or predefinable target position of the working device relative to the crane arm or to a predefined or predefinable direction in space, wherein there is provided at least one sensor for detecting an actual position of the working device relative to the crane arm or to the direction in space, the signals of which can be fed to the actuating device and the actuating device moves the working device into the target position in dependence on the signals of the at least one sensor if the actual position is not the same as the target position and the actuating device is adapted to assist or permit movements exerted by a user manually or pedally on the working device or on a load picked up by the working device or by gesture relative to the working device.

2. The lifting device according to claim 1, wherein the actuating device has a drive for varying a geometry of the crane arm, preferably in the form of a pivotal mechanism for the crane arm and at least one hydraulic cylinder for varying an angle of inclination of the crane arm, a bend position of the crane arm or an extension position of the crane arm and the position of the working device can be varied by the drive for varying the geometry of the crane arm.

3. The lifting device according to claim 1, wherein the actuating device has an actuator arranged between the crane arm and the working device, preferably in the form of a rotator, a rack or a hydraulic cylinder, and the position of the working device is variable by said actuator.

4. The lifting device according to claim 1, wherein the target position is a position of the working device with at least one predetermined angle in space.

5. The lifting device according to claim 1, wherein the at least one sensor is in the form of an angle sensor, a force or moment sensor, an inclination sensor, an acceleration sensor, a proximity sensor, an optical detection device or a device for emitting and receiving sound waves, in particular ultrasound, or a device for emitting and receiving electromagnetic waves, in particular radar or laser light.

6. The lifting device according to claim 1, wherein the actuating device has a control means to which the signals of the at least one sensor for detecting an actual position of the working device relative to the crane arm or the direction in space can be fed.

7. The lifting device according to claim 1, wherein the control means is arranged on the working device or is provided in a crane control means of the crane arm.

8. The lifting device according to claim 1, wherein there is provided at least one sensor, by means of which a variation caused by pick-up of a load by means of the working device in the position of the working device relative to the crane arm or relative to the direction in space or by which a mechanical loading caused by pick-up of a load by means of the working device—preferably a moment loading—of the working device can be detected.

9. The lifting device according to claim 1, wherein upon pick-up of a load engagement of the working device on the load outside the centre of gravity of the load can be detected.

10. The lifting device according to claim 1, wherein the at least one sensor for detecting an actual position of the working device forms the at least one sensor.

11. The lifting device according to claim 1, wherein the working device is in the form of a load pick-up means—in particular in the form of a manipulator, a rotator, a tilt rotator or a gripper, possibly with a respective actuator arranged thereon.

12. The lifting device according to claim 1, wherein the at least one sensor for detecting an actual position of the working device is arranged on or in the working device, on or in the crane arm or between the working device and the crane arm, or the sensor can be arranged on or in a vehicle.

13. The lifting device according to claim 1, wherein the lifting device is in the form of a loading crane.

14. A vehicle having the lifting device according to claim 1.
